(19) United States
(12) Patent Application Publication
(10) Pub. No.: US 2022/0092061 A1
(43) Pub. Date: Mar. 24, 2022

(54) METHOD FOR SEARCH IN STRUCTURED DATABASE, SEARCHING SYSTEM, AND STORAGE MEDIUM

(71) Applicant: BEIJING BAIDU NETCOM SCIENCE TECHNOLOGY CO., LTD., Beijing (CN)

(72) Inventors: Yuhan Cheng, Beijing (CN); Shichen Shao, Beijing (CN); Yufei Jin, Beijing (CN)

(73) Assignee: BEIJING BAIDU NETCOM SCIENCE TECHNOLOGY CO., LTD., Beijing (CN)

(21) Appl. No.: 17/457,770

(22) Filed: Dec. 6, 2021

(30) Foreign Application Priority Data
Mar. 15, 2021 (CN) 202110276512.0

(51) Int. Cl. G06F 16/248

(52) U.S. Cl. CPC G06F 16/248

(57) ABSTRACT

A method for search in a structured database comprises: receiving a search request input by a user, the search request including a plurality of search terms; searching the plurality of search terms in the structured database where a plurality of documents are stored in a structured manner; displaying at least one search result matching the plurality of search terms, wherein the at least one search result may be at least one document in the plurality of documents; receiving a selection on a search result in the at least one search result and displaying a document corresponding to the selected search result and document hit content, wherein the document hit content comprises at least one word matching the plurality of search terms and a context of the at least one word; and receiving a selection on a word in the at least one word and highlighting the word.

### CROSS-REFERENCETORELATEDAPPLICATION

The present application is based upon and claims priority to Chinese Patent Application No. 202110276512.0, filed on Mar. 15, 2021, the entire contents of which are incorporated herein by reference.

### TECHNICAL FIELD

The present disclosure relates to a computer technology, and more specifically, to a method for search in a structured database, a searching system, an electronic device, a storage medium, and a program product, which can be used in the fields of intelligent search and content query.

### BACKGROUND

With continuous development of the computer technology, users increasingly rely on information on the Internet, and often need to search for required information in the database through the Internet. Online document search is a technology that enables users to search for required documents from a database storing a large number of documents. Users can input a search term to perform a search operation in the database by using the search term, and obtain the document associated with the input search term. When performing a document search operation, users hope that an accurate and comprehensive search result may be obtained, and the time and computational resource required for the search operation may be as low as possible.

### SUMMARY

In a first aspect of the disclosure, a method for search in a structured database includes: receiving a search request input by a user, in which the search request includes a plurality of search terms; searching the plurality of search terms in the structured database, wherein the structured database comprises a plurality of documents stored in a structured manner; displaying at least one search result corresponding to the plurality of search terms, wherein the at least one search result corresponds to at least one document in the plurality of documents; receiving a selection on a search result in the at least one search result and displaying a document corresponding to the selected search result and document hit content, wherein the document hit content comprises at least one word corresponding to the plurality of search terms and a context of the at least one word in the document; and receiving a selection on a word in the at least one word and highlighting the word in the document.

In a second aspect of the disclosure, a searching system includes a user equipment, a structured database and a computing device. The structured database may store a plurality of documents and the computing device. The computing device may communicate with the user equipment via a first data transmission and communicate with a structured database via a second data transmission. The computing device may be configured to: receive a search request input by a user through the user equipment, in which the search request includes a plurality of search terms; search the plurality of search terms in the structured database, wherein the structured database comprises a plurality of documents stored in a structured manner; display at least one search result corresponding to the plurality of search terms, wherein the at least one search result corresponds to at least one document in the plurality of documents; receive a selection on a search result in the at least one search result and display a document corresponding to the selected search result and document hit content, wherein the document hit content comprises at least one word corresponding to the plurality of search terms and a context of the at least one word in the document; and receive a selection on a word in the at least one word and highlight the word in the document.

In a third aspect of the disclosure, there is provided a non-transitory computer-readable storage medium having computer instructions stored thereon. The computer instructions are configured to cause a computer execute the method in the first aspect of the present disclosure.

It is understood that the content described in the summary is not intended to limit the key or important features of the embodiments of the present disclosure, nor is it intended to limit the scope of the present disclosure. Other features of the present disclosure will be easily understood through the following description.

### BRIEF DESCRIPTION OF THE DRAWINGS

Through a more detailed description of the example embodiments of the present disclosure in combination with the drawings, the above and other objectives, features, and advantages of the present disclosure will be more apparent. In the example embodiments of the present disclosure, the same reference numbers generally represent the same component. It may be understood that the drawings are used to better understand the solution, and are not restrictive of the disclosure.

FIG. 1 is a block diagram illustrating a search environment/system 100 in which the method for search in a structured database in certain embodiments of the present disclosure can be implemented;

FIG. 2 is a flow chart illustrating a method 200 for search in a structured database according to an embodiment of the present disclosure;

FIG. 3 is a flow chart illustrating a method 300 for search in a structured database according to an embodiment of the present disclosure;

FIG. 4 is a block diagram illustrating an apparatus 400 for search in a structured database according to an embodiment of the present disclosure; and

FIG. 5 is a block diagram illustrating an exemplary electronic device 500 that can be used to implement the embodiments of the present disclosure.

In the various drawings, the same or corresponding numbers indicate the same component or a corresponding component.

### DETAILED DESCRIPTION

Hereinafter, preferred embodiments of the present disclosure will be described in details with reference to the drawings. Although the preferred embodiments of the present disclosure are shown in the drawings, it should be understood that the present disclosure can be implemented in various forms and should not be limited by the embodiments explained herein. On the contrary, these embodiments are provided to make the present disclosure more thorough and complete, and to fully convey the scope of the present disclosure to those skilled in the art.

The term “comprise/include” and its variants used herein means an open-ended inclusion, i.e., “comprise/include but not limited to”. Unless specifically stated, the term “or” means “and/or”. The term “based on” means “at least partly based on”. The terms “an exemplary embodiment” and “an embodiment” mean “at least an exemplary embodiment”. The term “another embodiment” means “at least one other embodiment”. The terms “first”, “second”, and the like may refer to different objects or the same object. The following may also include other explicit and implicit definitions.

As described above in the background, the conventional technology for searching documents has shortcomings in terms of search convenience, accuracy and comprehensiveness of search, and it also takes a lot of time for users to filter the search result, so it is difficult to satisfy users' needs.

Specifically, in the conventional solution, the document content search is performed based on the “title” and within the “the first 100 words of summary before the text” which can be referred to as an “abstract”. When the “title” and the “abstract” include content that matches the search terms, the document associated with the “title” and the “abstract” will appear in the search result. Then, the user needs to open the document appearing in the search result, and manually find the content associated with the search terms from the text of the document, so as to determine whether the searched document is the required document.

However, the conventional searching method the document content has many shortcomings. First of all, when the content associated with the search terms is located behind the first 100 words of the text in the document searched by the user, the document will probably not appear in the search result. At the same time, even if the user has a clear search requirement, it is difficult for the user to filter the search result for the second time, but can only view all the search results to determine whether the searched documents meet his own requirements. Secondly, when the user needs to specifically find the text content associated with the search terms in the searched document, the user needs to manually find the content location associated with the search terms after opening the searched document, which results in low search efficiency.

In order to at least partly solve one or more of the above problems and other potential problems, the embodiments of the present disclosure propose a searching method. With the technical solutions according to the embodiments of the present disclosure, a structured database can be used for searching, and the search terms and a list of their contexts hit in the document can be automatically and separately displayed when the user opens the document by selecting the search result, so that the user can jump to the corresponding content in the document. Therefore, the accuracy and efficiency of the search can be improved, which can improve the user experience.

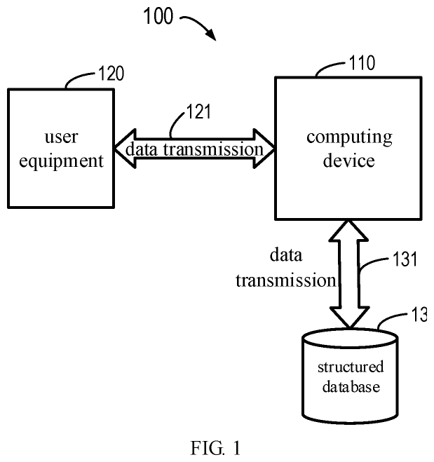

FIG. 1 is a block diagram illustrating a search environment 100 in which the method for search in a structured database in certain embodiments of the present disclosure can be implemented. According to one or more embodiments of the present disclosure, the search environment 100 may be a cloud environment. As illustrated in FIG. 1, the search environment 100 includes a computing device 110, a user equipment 120 and a structured database 130. In the search environment 100, the user equipment 120 can search the documents stored in the structured database 130 through the computing device 110. The computing device 110 may perform data transmission 121 with the user equipment 120 and data transmission 131 with the structured database 130.

It should be understood that the search environment 100 is only exemplary rather than restrictive, and it is extensible, which may include more computing devices 110, more user equipment 120, and more structured databases 130, so as to enable more users to search for documents simultaneously or non-simultaneously using more user equipment 120, more computing devices 110, and more structured databases 130 at the same time.

According to one or more embodiments of the present disclosure, in the search environment 100, the user equipment 120 may include devices such as mobile phones, personal digital assistants, and electronic devices with data input and data transmission functions. In the data transmission 121, the user may transmit, for example, a search request including search terms and search conditions to the computing device 110 through the user equipment 120. It should be understood that the search conditions may not be included in the search request.

Based on the received search request, the computing device 110 may search for documents corresponding to (e.g., matching to) the search request, especially corresponding to search terms included in the search requests, in the structured database 130 through the data transmission 131, may receive the search results corresponding to these documents from the structured database 130 through the data transmission 131, and may transmit the search results to the user equipment 120 through the data transmission 121.

Then, based on the received search results, the user can transmit search conditions for further filtering the search results or selection of the search results to the computing device 110 through the user equipment 120 via the data transmission 121, and the computing device 110 can further filter the search results and provide filtered search results to the user equipment 120 through the data transmission 121, or can provide the user equipment 120 with the document associated with the user's selection of search results through the data transmission 121, and also provide the document hit content that includes the word in the selected document that corresponds to the search term and the context of the word.

According to some embodiments of the present disclosure, the computing device 110 can record the document hit content associated with each document at the same time when searching documents, so that when the user selects a document, the document hit content associated with the document may be directly displayed.

According to other embodiments of the present disclosure, the computing device may not record the document hit content associated with each document when searching documents, but a search in a document is performed when a user selects the document, so as to determine the document hit content associated with the document.

After that, the user can select a hit word in the document hit content through the user equipment 120, and the display of the document can directly jump to the position of the word selected by the user, and the word and its context optionally can be highlighted. According to one or more embodiments of the present disclosure, the computing device 110 may jump to the position of the word selected by the user based on the coordinates of the hit word in the document hit content selected by the user.

According to one or more embodiments of the present disclosure, the documents stored in the structured database 130 may include reports or report forms associated with enterprises, journal articles, patents or patent applications, cases or prescriptions, and any documents suitable to be stored in the structured database 130 in a structured manner. For example, the above documents may be stored in the structured database 130 according to types and associated fields.

The reports or report forms associated with enterprises are taken as an example. The classification of reports or report forms associated with enterprises may include, for example, report numbers, report titles, upload times, report types, industries to which the reports belong, report release times, corporate code names or codes, authors, institutions to which the authors belong, numbers of pages, formats, special labels, and the like. The report types can include, for example, company financial reports, industry researches, company researches, macro researches, investment strategies, prospectus, papers on morning meetings, bond researches, fund researches, futures researches, options researches, foreign exchange researches, new OTC market researches, financial engineering reports and other reports. The industries to which the reports belong can include any industry such as a petroleum and petrochemical industry, a coal industry, and a non-ferrous metal industry. It should be understood that the above classification and types may correspond to various fields, and different reports or report forms may only include a part of fields used for structured storage in the structured database 130, and there is no need to include all fields.

The types of documents may include, for example, WORD documents and PDF documents. Since the structure of a PDF document is relatively complex, it may include various columns and headers and footers, it is more suitable to be stored in the structured database 130 in a structured manner, which helps locate later to the content associated with the search terms in the document.

According to one or more embodiments of the present disclosure, the structured database 130 may include tree catalogues associated with the classification and sub-classification of the stored documents, so as to enable to search for documents associated with search terms in the structured database 130 by traversing this tree catalogue.

In the search environment 100 illustrated in FIG. 1, the data transmission 121 and the data transmission 131 may be performed through a network. According to some embodiments of the present disclosure, the computing device 110 and the structured database 130 may be integrated together as a computing device with an independent capability of searching structured documents. At this time, the data transmission 131 may not be included in the search environment 100. According to other embodiments of the present disclosure, the computing device 110 and the user equipment 120 may be integrated together as a computing device with a capability of directly receiving search requests. At this time, the data transmission 121 may not be included in the search environment 100. According to another embodiments of the present disclosure, the computing device 110, the user equipment 120, and the structured database 130 can be integrated together as a computing device with the capability of directly receiving search requests and the independent capability of searching structured documents. At this time, the data transmission 121 and the data transmission 131 may not be included in the search environment 100.

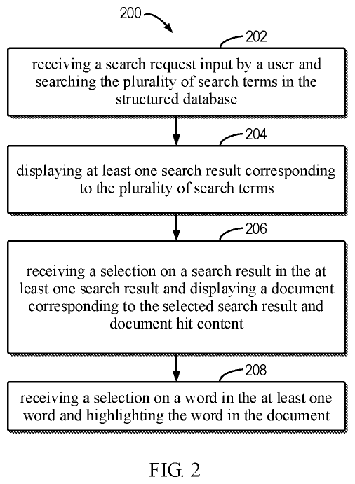

FIG. 2 is a flow chart illustrating a method 200 for search in a structured database according to an embodiment of the present disclosure. Specifically, the method 200 can be executed by the computing device 110 in the search environment 100 illustrated in FIG. 1. It should be understood that the method 200 may also include additional operations not shown and/or may omit operations shown, and the scope of the present disclosure is not limited in this respect.

In block 202, the computing device 110 receives a search request input by a user through the user equipment and searches the plurality of search terms in the structured database 130. According to one or more embodiments of the present disclosure, the search request includes a plurality of search terms and the structured database 130 includes documents stored in a structured manner as described above with reference to FIG. 1.

According to one or more embodiments of the present disclosure, the computing device 110 may search the plurality of search terms in the structured database based on a received search condition. The search condition includes, for example, a condition transmitted to the computing device 110 through the user equipment 120 and configured to reduce a number of results to be searched. Specifically, the search condition may include a condition of classifying the document, such as the category, author, and creation time of the document, and may also include an indication whether the document corresponding to the search result needs to include all the search terms.

In block 204, the computing device 110 displays at least one search result corresponding to the plurality of search terms. According to one or more embodiments of the present disclosure, at least one search result is obtained by the computing device 110 searching the search terms in the structured database 130, and the at least one search result corresponds to at least one document stored in the structured database 130 one by one. The search result may include the name of the document searched from the structured database 130 and content in the document, such as an abstract or a sentence that includes the search terms. It should be understood that displaying the search result by the computing device 110 may include the computing device 110 providing the search result to the user equipment 120 for display to the user.

According to some embodiments of the present disclosure, when there are a plurality of search terms, all the search terms should be included in the document corresponding to the search result. According to other embodiments of the present disclosure, when there are a plurality of search terms, only a part of search terms may be included in the document corresponding to the search result.

According to one or more embodiments of the present disclosure, the computing device 110 may sort the search results according to preset conditions. For example, the computing device 110 may sort the search results for display according to a number of search terms that appear in the document, whether the document includes all the search terms, or the date the document was created.

In block 206, the computing device 110 receives a selection on a search result in the at least one search result and displays a document corresponding to the selected search result and document hit content. According to one or more embodiments of the present disclosure, the selection on the search result in at least one search result may be made by the user through the user equipment 120, and the document hit content includes at least one word corresponding to the plurality of search terms and a context of at least one word in the document. The context of at least one word may be, for example, a sentence or a paragraph that includes the at least one word.

According to one or more embodiments of the present disclosure, the document hit content may be displayed in the document in a list, or simultaneously displayed in association with the document. At this time, each word and its context are displayed in, for example, an item in the list.

According to one or more embodiments of the present disclosure, displaying the document hit content by the computing device 110 may include the computing device 110 displaying at least one word and the context of the at least one word in a visually distinguishable manner. For example, the computing device 110 may display at least one word in red, and display the context of the at least one word in yellow, so that the user can easily distinguish the search word from its context in the displayed content.

In block 208, the computing device 110 receives a selection on a word in the at least one word and highlights the word in the document. According to one or more embodiments of the present disclosure, when a user selects a word in the document hit content through the user equipment 120, a part that includes the word in the document may be directly displayed and the word may be highlighted.

According to one or more embodiments of the present disclosure, the highlight display may include a color-changing display, an underlined display, a text box-added display, and other various display modes that enable the user to easily notice the highlighted content.

According to one or more embodiments of the present disclosure, the computing device 110 highlighting the word in the selected document may include the computing device 110 highlighting the word and the context of the word in the selected document, and may further include the computing device 110 highlighting the word and its context in the selected document in a visually distinguishable manner. For example, the computing device 110 may display the word in the selected document in red, and display the context of the word in yellow, so that the user can easily distinguish the hit search term from its context in the displayed content.

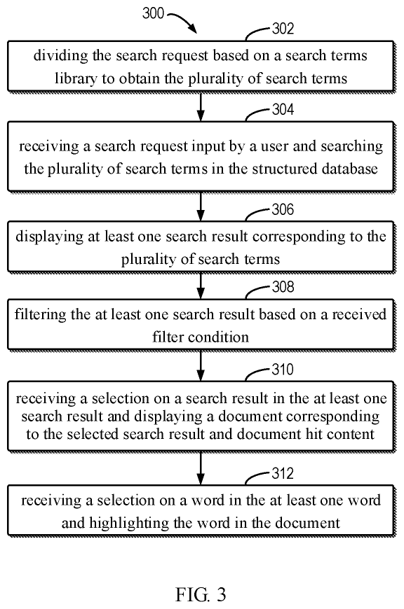

FIG. 3 is a flow chart illustrating a method 300 for search in a structured database according to an embodiment of the present disclosure. Specifically, the method 300 can be executed by the computing device 110 in the search environment 100 illustrated in FIG. 1. It should be understood that the method 300 may also include additional operations not shown and/or may omit operations, and the scope of the present disclosure is not limited in this respect.

In block 302, the computing device 110 divides received search requests based on a search terms library to obtain the search terms. According to one or more embodiments of the present disclosure, the search request input by the user to the computing device 110 through the user equipment 120 may be a sentence or a paragraph. At this time, the search request needs to be divided to obtain specific search terms. The search request may be divided, for example, based on the search terms library. The search terms library includes, for example, commonly used or available search terms. When the search requests are divided, the search terms in the search terms library will not be further divided. For example, when the search request is “recommending cheap computer screens”, this search request can be divided into four search terms “recommend”, “cheap”, “computer” and “screen”, which can be already stored in the search terms library. These four search terms will not be further divided. For example, the search term “computer” will not be divided into two search terms.

In block 304, the computing device 110 receives a search request input by a user through the user equipment and searches the plurality of search terms in the structured database 130. The specific content of the steps involved in block 304 is the same as the specific content of the steps involved in block 202, which will not be elaborated here.

In block 306, the computing device 110 displays at least one search result corresponding to the plurality of search terms. The specific content of the steps involved in block 306 is the same as the specific content of the steps involved in block 204, which will not be elaborated here.

In block 308, the computing device 110 filters the at least one search result based on a received filter request. According to one or more embodiments of the present disclosure, the filter requests include, for example, filter conditions transmitted to the computing device 110 through the user equipment 120 and configured to further reduce a number of results to be searched. Specifically, the filter conditions may include a classification condition of the document, such as the category, author, and creation time of the document, and may also include an indication whether the document corresponding to the search result needs to include all the search terms. It should be understood that the steps involved in block 308 are optional steps, and block 308 may not be included in method 300.

In block 310, the computing device 110 receives a selection on a search result in the at least one search result and displays a document corresponding to the selected search result and document hit content. The specific content of the steps involved in block 310 is the same as the specific content of the step involved in block 206, which will not be elaborated here.

In block 312, the computing device 110 receives a selection on a word in the at least one word and highlights the word in the document. The specific content of the steps involved in block 312 is the same as the specific content of the steps involved in block 208, which will not be elaborated here.

The above FIGS. 1 to 3 illustrate respectively, the search environment 100 in which the method for search in a structured database in some embodiments of the present disclosure can be implemented, the method 200 according to the embodiments of the present disclosure, and the method 300 according to the embodiments of the present disclosure. It should be understood that the above description is aimed at better describing the content recorded in the present disclosure, and is not intended to limit the present disclosure in any way.

It should be understood that a number of various elements and a size of the physical quantities used in the above drawings of the present disclosure are only examples, and are not intended to limit the protection scope of the present disclosure. The above numbers and sizes can be arbitrarily set as required, without affecting normal implementations of the embodiments of the present disclosure.

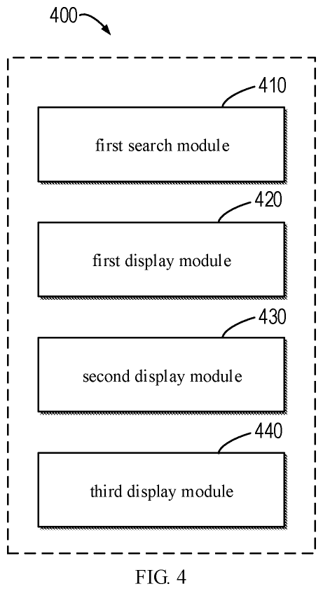

The details of the method 200 and the method 300 according to the embodiments of the present disclosure have been described above with reference to FIGS. 1 to 3. Hereinafter, each module in the apparatus will be described with reference to FIG. 4.

FIG. 4 is a block diagram illustrating an apparatus 400 for search in a structured database according to an embodiment of the present disclosure. As illustrated in FIG. 4, the apparatus 400 includes a first search module 410, a first display module 420, a second display module 430, and a third display module 440. The first search module 410 is configured to search in a structured database based on received search terms, in which the structured database includes documents stored in a structured manner. The first display module 420 is configured to display at least one search result corresponding to the search terms, in which the at least one search result corresponds to at least one document in the documents. The second display module 430 is configured to display, based on a received selection on a search result in the at least one search result, a selected document corresponding to the search result and document hit content, in which the document hit content includes the at least one word corresponding to the search terms in the selected document and a context of the at least one word. The third display module 440 is configured to highlight, based on a received selection on a word in the at least one word, the word in the selected document.

In one or more embodiments, the apparatus 400 further includes a division module (not shown). The division module is configured to divide received search requests based on a search terms library to obtain the search terms.

In one or more embodiments, the first search module 410 includes a second search module (not shown). The second search module is configured to search in the structured database based on the search terms and a received search condition.

In one or more embodiments, the search condition includes at least one of: document classification information; and whether a search result needs to match all search terms.

In one or more embodiments, the apparatus 400 further includes a filter module (not shown). The filter module is configured to filter the at least one search result based on a received filter condition.

In one or more embodiments, the filter condition includes at least one of: document classification information; and whether a search result needs to match all search terms.

In one or more embodiments, the second display module 430 includes a fourth display module (not shown). The fourth display module is configured to display the at least one word and the context of the at least one word in a visually distinguishable manner.

In one or more embodiments, the third display module 440 includes a fifth display module (not shown). The fifth display module is configured to highlight the word and the context of the word in the selected document.

In one or more embodiments, the fifth display module includes a sixth display module (not shown). The sixth display module is configured to highlight the word in the selected document and the context of the word in a visually distinguishable manner.

Through the above description with reference to FIGS. 1 to 4, the technical solution according to the embodiments of the present disclosure has many advantages over the traditional solution. For example, with the technical solution according to the embodiments of the present disclosure, a structured database can be used for searching, and the search terms and a list of their contexts hit in the document can be automatically and separately displayed when the user opens the document by selecting the search result, so that the user can jump to the corresponding content in the document. Therefore, the accuracy and efficiency of the search can be improved, which can improve the user experience.

According to the embodiments of the present disclosure, an electronic device, a computer-readable storage medium and a computer program product are also provided in the present disclosure.

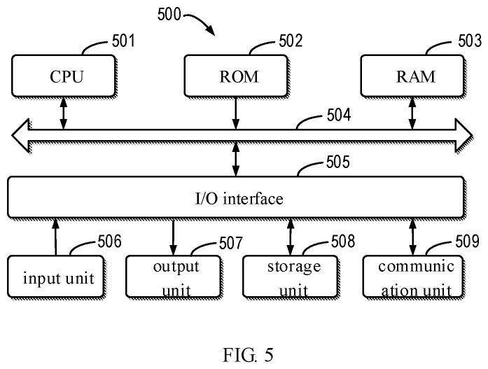

FIG. 5 is a block diagram illustrating an exemplary electronic device 500 that can be used to execute embodiments of the present disclosure. For example, the computing device 110 illustrated in FIG. 1 and the apparatus 400 illustrated in FIG. 4 may be executed by the electronic device 500. The electronic devices 500 is intended to represent various forms of digital computers, such as laptop computers, desktop computers, work tables, personal digital assistants, servers, blade servers, mainframe computers, and other suitable computers. Electronic devices can also represent various forms of mobile devices, such as personal digital processors, cellular phones, smart phones, wearable devices, and other similar computing devices. The components illustrated herein, their connections and relationships, and their functions are merely examples, and are not intended to limit the implementation of the disclosure described and/or claimed herein.

As illustrated in FIG. 5, the device 500 includes a computing unit 501, which can perform various appropriate actions and processes based on computer programs stored in the read-only memory (ROM) 502 or loaded from the storage unit 508 into the RAM 503. In the RAM 503, various programs and data required for the operations of the device 500 are also stored. The computing unit 501, the ROM 502, and the RAM 503 are connected to each other through a bus 504. The input/output (I/O) interface 505 is also connected to the bus 504.

A plurality of components in the device 500 are connected to the I/O interface 505, which includes an input unit 506, an output unit 507, a storage unit 508, and a communication unit 509. The input unit 506 may be, such as a keyboard, a mouse, and the like; the output unit 507 may be, such as various types of displays, speakers, and the like; and the storage unit 508 may be, such as a magnetic disk, an optical disk, and the like; and the communication unit 509 may be, such as a network card, a modem, a wireless communication transceiver, and the like. The communication unit 509 allows the device 500 to exchange information/data with other devices through a computer network such as the Internet and/or various telecommunication networks.

The computation unit 501 may be various general-purpose and/or special-purpose processing components with processing and computing capabilities. Some examples of the computing unit 501 include but are not limited to central processing units (CPU), graphics processing units (GPU), various dedicated artificial intelligence (AI) computing chips, various computing units running machine learning model algorithms, digital signal processors (DSP), and any appropriate processors, controllers, micro-controllers, and the like. The computing unit 501 executes each method and processing described above, such as the method 200 and the method 300. For example, in some embodiments, the method 200 and the method 300 can be implemented as a computer software program, which is tangibly included in a machine-readable medium, such as the storage unit 508. In some embodiments, a part or all of the computer programs may be loaded and/or installed on the device 500 via the ROM 502 and/or the communication unit 509. When the computer program is loaded into the RAM 503 and executed by the computing unit 501, one or more steps of the method 200 and the method 300 described above can be executed. Optionally, in other embodiments, the computing unit 501 may be configured to implement the method 200 and the method 300 by any other suitable means (for example, by firmware).

Various implementations of the systems and technologies described herein can be implemented in digital electronic circuit systems, integrated circuit systems, field programmable gate arrays (FPGA), application specific integrated circuits (ASIC), application-specific standard products (ASSP), systems on chip (SOC), complex programmable logic device (CPLD), computer hardware, firmware, software, and/or their combination thereof. These various embodiments may be executed in one or more computer programs, in which the one or more computer programs may be executed and/or interpreted on a programmable system including at least one programmable processor, in which the programmable processor may be a dedicated or general purpose programmable processor that can receive data and instructions from the storage system, at least one input apparatus, and at least one output apparatus, and transmit the data and instructions to the storage system, at least one input apparatus, and at least one output apparatus.

The program codes used to implement the method of the present disclosure can be written in any combination of one or more programming languages. These program codes can be provided to processors or controllers of general-purpose computers, special-purpose computers, or other programmable data processing apparatus, so that when the program codes are executed by a processor or a controller, functions/operations specified in flowcharts and/or block diagrams are implemented. The program codes can be entirely executed on a machine, partly executed on a machine, partly executed on a machine as an independent software package and partly executed on a remote machine, or entirely executed on a remote machine or a server.

In the context of the present disclosure, a machine-readable medium may be a tangible medium, which may include or store programs for use by instruction execution systems, apparatuses, or devices, or for use by the combination of instruction execution systems, apparatuses, or devices. The machine-readable medium may be a machine-readable signal medium or a machine-readable storage medium. The machine-readable medium may include, but is not limited to, an electronic, a magnetic, an optical, an electromagnetic, an infrared semiconductor system, apparatus, or device, or any suitable combination thereof. More specific examples of machine-readable storage medium may include an electrical connection based on one or more wires, portable computer disks, hard disks, RAMs, ROMs, erasable programmable read-only memories (EPROM or flash memories), optical fibers, portable compact disk read-only memories (CD-ROM), optical storage devices, magnetic storage devices, or any suitable combination thereof.

In order to provide interactions with the user, the systems and technologies described herein can be executed on a computer in which the computer includes a display device for displaying information to the user (for example, a CRT (cathode ray tube) or an LCD (liquid crystal display) monitor)); and a keyboard and a pointing device (for example, a mouse or a trackball) through which the user can provide the input to the computer. Other types of apparatus can also be used to provide interactions with the user; for example, the feedback provided to the user can be any form of sensory feedback (for example, a visual feedback, an auditory feedback, or a tactile feedback); and can be in any form (for example, an acoustic input, a voice input, or a tactile input) to receive the input from the user.

The systems and technologies described herein can be executed in a computing system that includes back-end components (for example, as a data server), or a computing system that includes middleware components (for example, an application server), or a computing system that includes front-end components (for example, a user computer with a graphical user interface or web browser through which the user can interact with the implementation of the systems and technologies described herein), or a computing system that includes any combination of the back-end components, middleware components, or front-end components. The components of the system can be connected to each other through any form or medium of digital data communication (for example, a communication network). Examples of communication networks include: local area networks (LAN), wide area networks (WAN), and the Internet.

The computer system may include a client and a server. The client and server are generally far away from each other and usually interact through a communication network. The relationship between the client and the server is generated by computer programs that run on the corresponding computer and have a client-server relationship with each other.

It should be understood that the various forms of processes illustrated above can be used to reorder, add or delete steps. For example, the steps described in the present disclosure can be executed in parallel, sequentially, or in a different order, as long as the desired result of the technical solution disclosed in the present disclosure can be achieved, this is not limited herein.

The above specific implementations do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of this disclosure.

What is claimed is:

1. A method for search in a structured database, comprising:
receiving a search request input by a user, in which the search request includes a plurality of search terms;
searching the plurality of search terms in the structured database, wherein the structured database comprises a plurality of documents stored in a structured manner;
displaying at least one search result corresponding to the plurality of search terms, wherein the at least one search result corresponds to at least one document in the plurality of documents;
receiving a selection on a search result in the at least one search result and displaying a document corresponding to the selected search result and document hit content, wherein the document hit content comprises at least one word corresponding to the plurality of search terms and a context of the at least one word in the document; and
receiving a selection on a word in the at least one word and highlighting the word in the document.

2. The method of claim 1, further comprising:
dividing the search request based on a search terms library to obtain the plurality of search terms.

3. The method of claim 1, wherein searching the plurality of search terms in the structured database comprises:
searching the plurality of search terms in the structured database based on a received search condition.

4. The method of claim 3, wherein the received search condition comprises at least one of:
document classification information; and
whether a search result needs to match all the search terms.

5. The method of claim 1, further comprising:
filtering the at least one search result based on a received filter condition.

6. The method of claim 5, wherein the filter condition comprises at least one of:
document classification information; and
whether a search result needs to match all the search terms.

7. The method of claim 1, wherein displaying the document hit content comprises:
displaying the at least one word and the context of the at least one word in a visually distinguishable manner.

8. The method of claim 1, wherein highlighting the word in the document comprises:
highlighting the word and the context of the word in the document.

9. The method of claim 8, wherein highlighting the word and the context of the word in the document comprises:
highlighting the word and the context of the word in the document in a visually distinguishable manner.

10. A searching system, comprising:
a user equipment;
a structured database that stores a plurality of documents; and
a computing device that communicates with the user equipment via a first data transmission and communicates with a structured database via a second data transmission;
wherein the computing device is configured to:
receive a search request input by a user through the user equipment, in which the search request includes a plurality of search terms;
search the plurality of search terms in the structured database, wherein the structured database comprises a plurality of documents stored in a structured manner;
display at least one search result corresponding to the plurality of search terms, wherein the at least one search result corresponds to at least one document in the plurality of documents;
receive a selection on a search result in the at least one search result and display a document corresponding to the selected search result and document hit content, wherein the document hit content comprises at least one word corresponding to the plurality of search terms and a context of the at least one word in the document; and
receive a selection on a word in the at least one word and highlight the word in the document.

11. The system of claim 10, wherein the computing device is further configured to:
divide the search request based on a search terms library to obtain the plurality of search terms.

12. The system of claim 10, wherein the computing device is further configured to search the plurality of search terms in the structured database based on a received search condition.

13. The system of claim 12, wherein the received search condition comprises at least one of:
document classification information; and
whether a search result needs to match all the search terms.

14. The system of claim 10, wherein the computing device is further configured to filter the at least one search result based on a received filter condition.

15. The system of claim 14, wherein the filter condition comprises at least one of:
document classification information; and
whether a search result needs to match all the search terms.

16. The system of claim 10, wherein the computing device is further configured to display the at least one word and the context of the at least one word in a visually distinguishable manner.

17. The system of claim 10, wherein the computing device is further configured to highlight the word and the context of the word in the document.

18. The system of claim 17, wherein the computing device is further configured to highlight the word and the context of the word in a visually distinguishable manner.

19. A non-transitory computer-readable storage medium having computer instructions stored thereon, wherein the computer instructions are configured to cause a computer to execute a method for search in a structured database, the method comprising:
receiving a search request input by a user, in which the search request includes a plurality of search terms;
searching the plurality of search terms in the structured database, wherein the structured database comprises a plurality of documents stored in a structured manner;
displaying at least one search result corresponding to the plurality of search terms, wherein the at least one search result corresponds to at least one document in the plurality of documents;
receiving a selection on a search result in the at least one search result and displaying a document corresponding to the selected search result and document hit content, wherein the document hit content comprises at least one word corresponding to the plurality of search terms and a context of the at least one word in the document; and
receiving a selection on a word in the at least one word and highlighting the word in the document.

20. The storage medium of claim 19, wherein the method further comprises:
dividing the search request based on a search terms library to obtain the plurality of search terms.
